(19) United States
(12) Patent Application Publication
(10) Pub. No.: US 2008/0272927 A1
(43) Pub. Date: Nov. 6, 2008

(54) ILLUMINATED FEEDBACK FOR A TOUCHPAD BY PROVIDING A LIGHT SOURCE THAT IS ASSOCIATED WITH A FINGER POSITION ON A TOUCHPAD

(76) Inventors: Richard D. Woolley, Orem, UT (US); Don T. Saxby, Salt Lake City, UT (US)

Correspondence Address: MORRISS OBRYANT COMPAGNI, P.C., 734 EAST 200 SOUTH, SALT LAKE CITY, UT, 84102, US

(21) Appl. No.: 12/113,861

(22) Filed: May 1, 2008

Related U.S. Application Data
(60) Provisional application No. 60/915,297, filed on May 1, 2007.

(51) Int. Cl. G08B 5/00; G06F 3/041

(52) U.S. Cl. 340/815.4; 345/173

(57) ABSTRACT

A touchpad having illumination directed upwards through a substrate of the touchpad, wherein the substrate is sufficiently transparent or translucent such that light from underneath the substrate is at least partially visible through the touchpad to a user thereof.

### CROSS REFERENCE TO RELATED APPLICATIONS

This document claims priority to and incorporates by reference all of the subject matter included in the provisional patent application docket number 3857.CIRQ.PR, having Ser. No. 60/915,297 and filed on May 1, 2008, and in patent application docket number 1677.CIRQ.CI1.CN, having Ser. No. 11/641,620 and filed on Dec. 19, 2002.

### BACKGROUND OF THE INVENTION

1. Field of the Invention

This invention relates generally to touchpads. More specifically, the invention relates to touchpads for use in devices that can benefit from a visual indicator of the present position of a finger or other pointing object on or in proximity of a touchpad surface.

2. Description of Related Art

As touchpads become used in more and more devices, it is often useful to provide more feedback to a user so that the device is easier to use. For example, many touchpads are disposed in devices that are used in poor lighting conditions, or even in the dark. However, it is not necessary to use a device in the dark in order to benefit from improved visual feedback. What is needed is a way to provide improved visual feedback to a user of a device that has a touchpad for user input.

One such touchpad that can provide improved visual feedback is designed and manufactured by CIRQUE® Corporation. The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

It should be understood that the there are other touchpad technologies that can also benefit from the present invention. Accordingly, any touchpad that can provide visual clues to a user as to the present location of a finger or other pointing object on the touchpad can be used.

The state of the art in using illumination in input devices is characterized by keyboards. Illumination is typically provided by providing a light underneath a keyboard. The light under the keys then shines through or otherwise illuminates a transparent or translucent designation on the keys. Accordingly, each letter or label on the key is illuminated.

In touchpads, illumination is generally unknown except when used in conjunction with keys of a keymat or keypad, as in U.S. Pat. No. 7,151,528 issued to Cirque® Corporation. In this patent, illumination is provided under the keys of a mobile telephone keypad. The illumination has nothing to do with the touchpad or its operation. The touchpad is simply operating in conjunction with the keypad, and the touchpad design must accommodate use of LEDs so that they can be used to illuminate keys of the keypad.

It would be an advantage over the state of the art in touchpad design to use LEDs or some other means of illumination to provide some useful feedback to the user of a touchpad.

### BRIEF SUMMARY OF THE INVENTION

In a first embodiment, the present invention is a touchpad having illumination directed upwards through a substrate of the touchpad, wherein the substrate is sufficiently transparent or translucent such that light from underneath the substrate is at least partially visible through the touchpad to a user thereof.

In a first aspect of the invention, the illumination tracks the motion of a pointing object on or in proximity of a touchpad surface.

In a second aspect of the invention, the illumination under the touchpad also illuminates an overlay that may be disposed over the touchpad substrate, wherein the overlay is transparent or translucent to thereby enable the light to be visible to a user.

In a third aspect of the invention, the illumination is sufficient to make images visible that are disposed on an overlay.

In a fourth aspect of the invention, the touchpad is combined with an LCD display screen because the LCD display screen is capable of generating various colors or images underneath a point of contact.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a schematic diagram of the prior art capacitance sensitive touchpad provided by CIRQUE® Corporation.

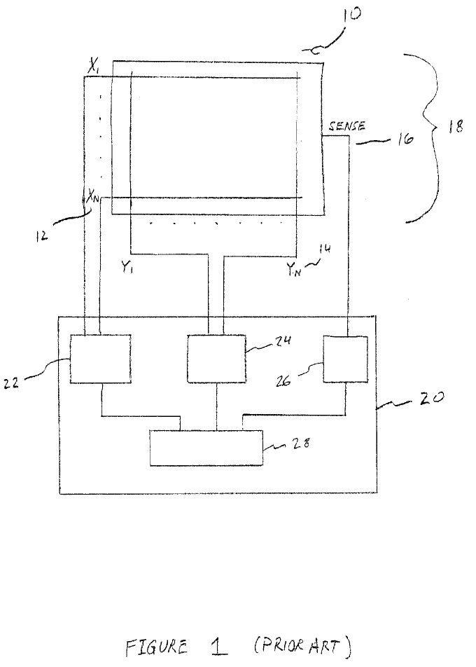

FIG. 2 is a profile cut-away view of a touchpad substrate, wherein illumination is provided underneath the substrate using a plurality of LEDs.

FIG. 3 is a block diagram of components of a system such as the system shown in FIG. 2.

FIG. 4 is a profile view of a touchpad substrate, wherein illumination is provided underneath the substrate using an LCD display screen.

FIG. 5 is a profile view of a touchpad and LCD display screen, wherein the touchpad is now disposed underneath the LCD display screen.

FIG. 6 is a perspective view of a touchpad and an area of illumination that is a circle.

FIG. 7 is a perspective view of a touchpad and an area of illumination that is a ring.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

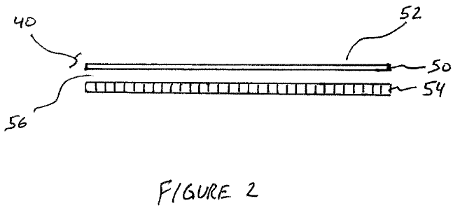

The present invention is a system and method for using light as feedback to a user of a touchpad. While many keypads have illuminated keys, touchpads are not known to have such a feedback feature. Accordingly, the first embodiment of the present invention is shown in FIG. 2 to be a touchpad 40 having a substrate 50 that is translucent to transparent. What is important is that light is at least partially visible through the substrate 50.

In this first embodiment, the touchpad 40 includes a surface 52 that is translucent to transparent. The surface 52 can just be a top layer of the substrate 50, or it can be a separate material that is disposed on top of the substrate. For example, an overlay 52 can be disposed on top of the substrate 50. The overlay 52 can serve various functions such as protection for the substrate 50 as well as a display of various regions, zones or buttons of the touchpad 40. What is important is that the overlay 52 also be transparent or translucent so that the illumination can show through.

By making the overlay 52 or the substrate 50 itself only partially transparent or translucent, various designs, symbols, letters, numbers or images can be illuminated when a pointing object (including a finger or stylus) are disposed on or over the touchpad 40.

It is not necessary that actual contact be made with the surface 52 when using a proximity sensing touchpad 40. For example, a proximity sensing touchpad only requires that a pointing object comes within a threshold distance in order to be detectable by the touchpad 40. By not making contact and covering the area of contact, the illumination from below is even more visible than when contact is made. Nevertheless, even when the touchpad 40 is used in a contact mode, the illumination should be made in an area around the point of contact that is sufficiently large such that it can be seen around the point of contact made by the pointing object.

The illumination that shines through the substrate 50 and an overlay 52 if present can be provided by any convenient source. It is envisioned that there are many suitable means of illumination available. The specific illumination means selected is not a critical aspect of the invention.

Accordingly, in the first embodiment shown in FIG. 2, a plurality of individual light emitting diodes (LEDs) 54 are disposed in an array underneath the touchpad substrate 50. There may or may not be a gap 56 between the substrate 50 and the LEDs 54 beneath. An air gap 56 has been arbitrarily included in this illustration. All that is important is that the LEDs 54 be visible from beneath the substrate 50.

The number of LEDs used in the plurality of LEDs 54 of the array may be varied as desired. In this first embodiment, a number of LEDs 54 are being used such that the location of a finger on the surface 52 can be illuminated to enable a user to see the light emitted from the plurality of LEDs around the edges of the finger.

It should be noted that it is most likely going to be necessary to illuminate a plurality of LEDs 54 in order that the illumination be bright enough or wide enough around the location of the finger on the surface 52 to be seen. Turning on a plurality of LEDs 54 may be especially important depending upon the size of the individual LEDs 54 being used.

The illumination provided by a light source under the substrate 50 is preferably bright enough to be visible in a lighted room, but it may also be only dim enough to be seen in a darkened area. It is also envisioned that the brightness of the plurality of LEDs 54 is adjustable so that a user can provide a desired level of illumination. It is also a means of conserving battery life by reducing the intensity of illumination.

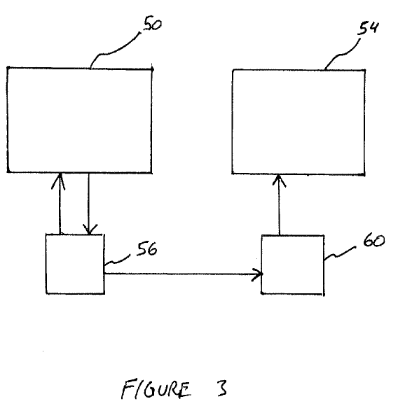

FIG. 3 is a block diagram of a system that includes controlling a source of illumination. For example, the plurality of LEDs 54 can be controlled by a control circuit 60. The control circuit 60 receives location information of the pointing object on or in proximity of the touchpad 40 from touchpad control circuitry 56. This information is then used to determine which of the plurality of LEDs 54 should be lit. Such information can be obtained, for example, from a matrix that correlates position of the pointing object with specific LEDs that should be lit.

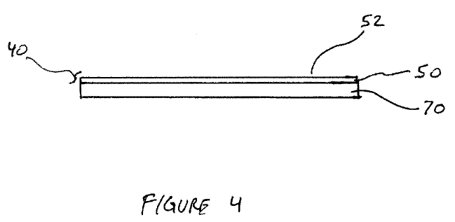

Another embodiment of the invention can use liquid crystal display (LCD) technology as shown in FIG. 4. For example, an LCD display screen 70 might be disposed underneath the touchpad 40, comprised of the substrate 50 and a surface 52 that might also be an overlay. In this way, light generated by the LCD display screen 70 can be seen through the substrate 50 (and the overlay 52 if present).

In this embodiment, the location of a pointing object is used by touchpad circuitry to cause the LCD display screen 70 to generate a visible light underneath or perhaps only encircling the position of the pointing object. The LCD display screen 70 has the advantage of being able to generate any desired color of light, shape of light, or pattern. This may be particularly useful if the function being performed by the touchpad 40 can be associated with a specific color, shape or pattern of light, providing the user with further useful feedback about the function being performed.

For example, when the touchpad 50 is operating as a cursor control device, the LCD display screen 70 can generate a bright red light underneath the user's finger. However, when a scrolling function is being performed, the color of the light can be changed to a different color. The user would always know what “mode” or function was being performed by the touchpad 40 simply by the color of the light being projected underneath the user's finger.

The functions or modes of operation that can be performed by the touchpad should not be considered limited to cursor control and scrolling. The functions should be considered to be any that can be performed by a touchpad, such as providing buttons, controlling a zoom function, and controlling a particular variable.

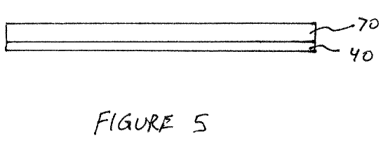

FIG. 5 shows that the configuration of components shown in FIG. 4 can be rearranged, such that the LCD display screen 70 is now the top layer, and a touchpad 40 is disposed underneath. The LCD display screen 70 continues to illuminate the area under the pointing object.

It is envisioned that other means of illuminating through the substrate 50 can also be used. For example, a single or a plurality of electroluminescent panels might also be used. What is important is that selected areas of the substrate 50 can be illuminated from underneath the pointing object. The area of illumination will also appear to move as the finger moves on or in proximity of the surface 52.

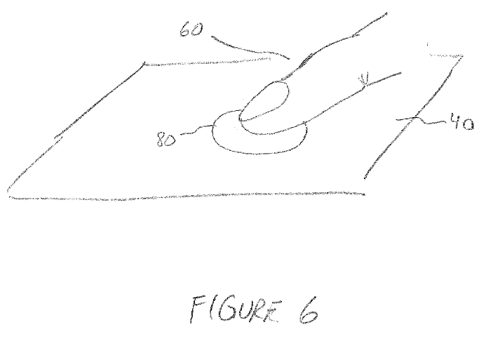

FIG. 6 is provided as an illustration of how the area under a pointing object might appear when it is illuminated. In this figure, the pointing object 60 is shown making contact with the touchpad 40. The area is shown as an illuminated circle 80 that is only partially covered by and centered around the pointing object 60. The size of the illuminated circle 80 can be adjusted as desired.

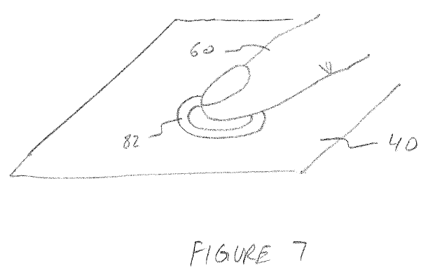

FIG. 7 is provided to illustrate a different shape for the area of illumination. In this figure, the area of illumination is a ring 82. The thickness of the ring 82 can be adjusted so that most fingers 60 will not obscure the ring.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method of illuminating a point of contact underneath a pointing object as it moves along a touch sensitive surface, said method comprising the steps of:
1) providing a touchpad capable of detecting and tracking an object moving along a surface thereof;
2) providing a source of illumination, wherein the source of illumination is disposed underneath the touchpad; and
3) illuminating an area underneath a pointing object as it makes contact with and moves along a surface of the touchpad, wherein illumination from the source of illumination is visible around edges of the pointing object.

2. The method as defined in claim 1 wherein the method further comprises the step of making a substrate of the touchpad transparent or translucent so that the illumination is visible through the touchpad.

3. The method as defined in claim 1 wherein the method further comprises the step of selecting the source of illumination from the group of sources of illumination comprised of light emitting diodes, liquid crystal display screens, and electroluminescent panels.

4. The method as defined in claim 1 wherein the method further comprises the step of illuminating an area underneath the pointing object in the shape of a circle.

5. The method as defined in claim 1 wherein the method further comprises the step of illuminating an area underneath the pointing object in the shape of a ring.

6. The method as defined in claim 1 wherein the method further comprises the step of making the source of illumination variable in intensity.

7. The method as defined in claim 1 wherein the method further comprises the step of changing a color of the source of illumination.

8. The method as defined in claim 1 wherein the method further comprises the step of providing a plurality of different colors of illumination, wherein each of the plurality of different colors correspond to a different function being performed with the touchpad.

9. The method as defined in claim 8 wherein the method further comprises the step of selecting the different functions of the touchpad from a group of different functions comprised of scrolling, zooming, using a virtual touchpad button, and moving a cursor.

10. The method as defined in claim 1 wherein the method further comprises the step of disposing an overlay over the touchpad, wherein the overlay is transparent or translucent to the illumination.

11. The method as defined in claim 10 wherein the method further comprises the step of providing at least one image on the overlay that is made visible by the illumination.

12. A system for illuminating a point of contact underneath a pointing object as it moves along a touch sensitive surface, said system comprised of:
a touchpad capable of detecting and tracking an object moving along a surface thereof;
a source of illumination, wherein the source of illumination is disposed underneath the touchpad, wherein an area underneath a pointing object is illuminated as it makes contact with and moves along a surface of the touchpad, wherein illumination from the source of illumination is visible around edges of the pointing object.

13. The system as defined in claim 12 wherein the system is further comprise of a transparent or translucent substrate.

14. The system as defined in claim 12 wherein the system is further comprised of selecting the source of illumination from the group of sources of illumination comprised of light emitting diodes, liquid crystal display screens, and electroluminescent panels.

15. The system as defined in claim 12 wherein the system is further comprised of making the illuminated area underneath the pointing object in the shape of a circle.

16. The system as defined in claim 12 wherein the system is further comprised of making the illuminated area underneath the pointing object in the shape of a ring.

17. The system as defined in claim 12 wherein the system is further comprised of means for making the source of illumination variable in intensity.

18. The method as defined in claim 12 wherein the system is further comprised of means for changing a color of the source of illumination.

19. The system as defined in claim 12 wherein the system is further comprised of providing a plurality of different colors of illumination, wherein each of the plurality of different colors correspond to a different function being performed with the touchpad.

20. The method as defined in claim 19 wherein the system is further comprised of selecting the different functions of the touchpad from a group of different functions comprised of scrolling, zooming, using a virtual touchpad button, and moving a cursor.

21. The system as defined in claim 12 wherein the system is further comprised of an overlay disposed over the touchpad, wherein the overlay is transparent or translucent to the illumination.

22. The system as defined in claim 21 wherein the system is further comprised of at least one image disposed on the overlay that is made visible by the illumination.
